(19) United States
(12) Patent Application Publication
(10) Pub. No.: US 2026/0017775 A1
(43) Pub. Date: Jan. 15, 2026

(54) SYSTEM AND METHOD FOR DETECTING DEFECTS ON SPECIMENS

(71) Applicant: Nanotronics Imaging, Inc., Cuyahoga Falls, OH (US)

(72) Inventors: Jacob Keith, Brooklyn, NY (US); Joanna Lee, Brooklyn, NY (US)

(73) Assignee: Nanotronics Imaging, Inc., Cuyahoga Falls, OH (US)

(21) Appl. No.: 18/768,849

(22) Filed: Jul. 10, 2024

(51) Int. Cl. G06T 7/00

(52) U.S. Cl. CPC G06T 7/001; G06T 2207/20081; G06T 2207/30148

(57) ABSTRACT

A computer-implemented method for detecting defects on specimens in an inspection system is disclosed herein. A first set of images of a plurality of specimens having defects formed thereon is received. A second set of images of the plurality of specimens is received, the second set of images includes the plurality of specimens after undergoing a destructive etch process and labels corresponding to each defect. Labels from the second set of images are transferred to the first set of images. A machine learning model is trained to classify defects on unetched specimens based on the first set of images and the labeled first set of images. Once the machine learning model has achieved a threshold of accuracy, the machine learning model may be deployed in the inspection system.

### TECHNICAL FIELD

Embodiments disclosed herein generally relate to systems and methods for detecting defects on specimens.

### BACKGROUND

Inspection of specimens, such as, but not limited to substrates and photomasks, for defects and other characteristics is important for manufacturing processes. For example, in the integrated circuit manufacturing space, since the entire semiconductor manufacturing process involves hundreds of steps, it is important to detect defects on the substrate or mask early in the manufacturing process.

### SUMMARY

In some embodiments, a computer-implemented method for detecting defects on specimens in an inspection system is disclosed herein. A first set of images of a plurality of specimens having defects formed thereon is received. A second set of images of the plurality of specimens is received. The second set of images includes the plurality of specimens after undergoing a destructive etch process and labels corresponding to each defect. Labels are transferred from the second set of images to the first set of images. A machine learning model is trained to classify defects on unetched specimens based on the first set of images and the labeled first set of images. The machine learning model is determined to have achieved a threshold of accuracy. Based on the determining, the machine learning model is deployed in the inspection system.

In some embodiments, a non-transitory computer readable medium is disclosed herein. The non-transitory computer readable medium includes one or more sequences of instructions stored thereon, which, when executed by a processor, causes a computing system to perform operations. The operations include receiving a first set of images of a plurality of specimens having defects formed thereon. The operations further include receiving a second set of images of the plurality of specimens. The second set of images includes the plurality of specimens after undergoing a destructive etch process and labels corresponding to each defect. The operations further include transferring labels from the second set of images to the first set of images. The operations further include training a machine learning model to classify defects on unetched specimens based on the first set of images and the labeled first set of images. The operations further include determining that the machine learning model has achieved a threshold of accuracy. The operations further include, based on the determining, deploying the machine learning model in an inspection system.

In some embodiments, a system is disclosed herein. The system includes a processor and a memory. The memory has programming instructions stored thereon, which, when executed by the processor, causes the system to perform operations. The operations include receiving a first set of images of a plurality of specimens having defects formed thereon. The operations further include receiving a second set of images of the plurality of specimens. The second set of images includes the plurality of specimens after undergoing a destructive etch process and labels corresponding to each defect. The operations further include transferring labels from the second set of images to the first set of images. The operations further include training a machine learning model to classify defects on unetched specimens based on the first set of images and the labeled first set of images. The operations further include determining that the machine learning model has achieved a threshold of accuracy. The operations further include, based on the determining, deploying the machine learning model in an inspection system.

### BRIEF DESCRIPTION OF THE FIGURES

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1 illustrates an example system environment, according to example embodiments of the present disclosure.

FIG. 2 is a block diagram illustrating a deep learning processor for training of defects, according to example embodiments of the present disclosure.

FIG. 3 is a block diagram illustrating a deep learning processor for deployment of training of defects, according to example embodiments of the present disclosure.

FIG. 4 is a flow diagram illustrating a method for generating a training data set to train a machine learning model to detect defects, according to example embodiments of the present disclosure.

FIG. 5 is a flowchart for a method for detecting defects on a specimen in an inspection system, according to example embodiments of the present disclosure.

FIG. 6 illustrates a specimen S with micropits thereon, according to some embodiments.

FIG. 7 is a flow diagram illustrating a method of inspecting a specimen for micropits, according to example embodiments.

FIG. 8A is a block diagram illustrating a computing device, according to example embodiments of the present disclosure.

FIG. 8B is a block diagram illustrating a computing device, according to example embodiments of the present disclosure.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

The present disclosure is generally directed to systems and methods for detecting defects on specimens. Generally, a defect, or artifact, on a specimen may refer to defect, artifact, or abnormality located on a specimen or a portion of a specimen. In some embodiments, defects may be electron-based, and the specimen may be an electronic device, such as a transistor, resistor, capacitor, integrated circuit, microchip, and the like. In some embodiments, defects may include defects on a bulk material such as cracks, scratches, impurities, structural imperfections, irregularities, stacking faults, contaminants, crystallographic defects, scratches, dust, fingerprints, chips, and the like on a substrate or integrated circuit.

As those skilled in the art understand, there is a difference between being able to detect a defect on a specimen compared to classifying a detected defect on a specimen. Not all defects are created equally. For example, some defects are critical defects, and some defects are non-critical defects. The existence of a critical defect, for example, may result in one or more corrective actions to correct or account for the critical defect. In some instances, the existence of a critical defect may result in disposal of the specimen under manufacture. On the other hand, the existence of non-critical defects may not result in disposal of the specimen under manufacture. Instead, non-critical defects may be permissible in certain circumstances. While the current state of technology is well versed at being able to detect defects—both critical and non-critical alike, the current state of technology is unable to delineate between critical defects and non-critical defects without destructive testing of the specimen under manufacture.

Using a first non-limiting example, the current state of technology is able to detect two types of defects: a threading screw defect and a threading edge defect. As those skilled in the art understand, a specimen may have a small number of threading screws defects (e.g., around ten defects) but a large number of threading edge defects (e.g., up to a million). Despite the difference in occurrences, threading screw defects are considered critical because they may ruin the specimen; in comparison, threading edge defects are considered non-critical defects. Thus, it is important to be able to not only detect threading screw defects and threading edge defects, but also to be able to distinguish between threading screw defects and threading edge defects. An issue arises when critical defects (e.g., threading screw defects) are indistinguishable from non-critical defects (e.g., threading edge defects) during inspection. Currently, conventional inspection techniques are unable to distinguish between threading screw defects and threading edge defects without destructive etch testing, which would ruin the specimen under manufacture.

Using a second non-limiting example, during integrated circuit fabrication, micropits may occur on a surface of a specimen. A micropit may refer to a small hole or indent in a surface of a specimen, typically, but not limited to, small holes or indents under 500 nm. While micropits can be detected, it is often difficult to decipher between micropits and other components formed on the surface of the specimen that may reflect light very similar to that of micropits. Currently, there is no solution for detecting and classifying a micropit defect.

One or more techniques discussed herein provide an improvement over conventional defect detection and classification systems. In some embodiments, one or more technique disclosed herein provide a machine learning model that may be trained to distinguish between defects that would otherwise require a destructive etch process in order to classify these defects. Such process may involve a transferred learning training, through which etched substrates and unetched substrates are provided as training data to the machine learning model. In this manner, the defect detection system is able to learn how to classify certain defects that are historically only able to be classified once a destructive etch process is performed. In some embodiments, one or more techniques disclosed herein provide a machine learning model that may be trained to identify and classify micropits.

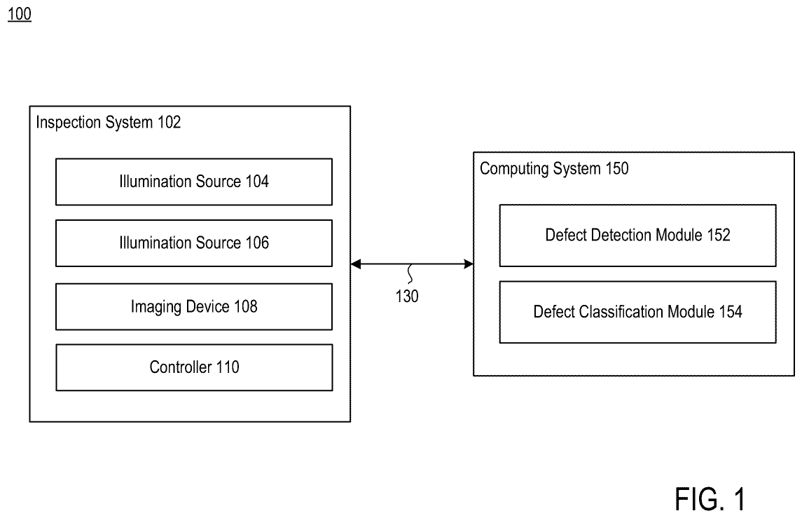

FIG. 1 illustrates an exemplary computing environment 100 for inspection of a specimen supported on a stage, according to exemplary embodiments. As shown, computing environment 100 may include an inspection system 102 in communication with a computing system 150, according to example embodiments.

Inspection system 102 may be configured to inspect a specimen for defects. For example, inspection system 102 may include one or more light sources 104, 106. Each light source 104, 106 may be configured to illuminate a specimen. In some embodiments, one or more light sources 104, 106 may be representative of brightfield light sources. In some embodiments, one or more light sources 104, 106 may be representative of darkfield light sources. For example, when operating in darkfield mode, one or more light sources 104, 106 may be configured to direct oblique light toward specimen at an angle. The oblique illumination may be reflected from a surface of specimen as reflected light.

In some embodiments, inspection system 102 may include an imaging device 108. Imaging device 108 may include an image sensor. The image sensor may be configured to capture light reflected off the specimen. In some embodiments, light sources 104, 106 may be moved to different positions located circumferentially around the object, with images taken at each position.

In some embodiments, inspection system 102 may include a controller 110. Controller 110 may be configured to control one or more light sources 104, 106 and imaging device 108. For example, controller 110 may control one or more of a position, intensity, or color of light sources 104, 106. In some embodiments, controller 110 may be configured to control a frequency at which imaging device 108 captures images of the specimen under manufacture.

In some embodiments, inspection system 102 may provide the images captured by imaging device 108 to computing system 150 for processing. Computing system 150 may be in communication with inspection system 102 via one or more communication channels 130. In some embodiments, the one or more communication channels may be representative of individual connections via the Internet, such as cellular or Wi-Fi networks. In some embodiments, the one or more communication channels may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN.

Computing system 150 may be configured to analyze the images captured by imaging device 108 for detect and classify defects on the specimen. As shown, computing system 150 may include defect detection module 152 and defect classification module 154. Defect detection module 152 may be representative of an artificial intelligence-based module or computer-vision based module configured to detect defects on a surface of a specimen. In some embodiments, such as when the specimen is a KOH etched SiC sample, the images may be captured using a brightfield optical microscopy system and defect detection module 152 may be representative of a computer- vision based artifact detector configured to isolate defects within those images. In some embodiments, such as when the specimen is a GaN/Si epi substrate, the images may be captured using a darkfield microscopy system and defect detection module 152 may be representative of an artificial intelligence module.

Defect classification module 154 may be configured to classify defects detected by defect detection module 152. For example, defect classification module 154 may include one or more artificial intelligence algorithms trained to decipher between types of defects detected by defect detection module 152. For example, as discussed above and in more detail below, defect classification module 154 may be trained to classify defects that are traditionally difficult or impossible to classify without destructive testing of the specimen. In this manner, defect classification module 154 provides a substantial improvement over conventional defect detection and classification systems.

Further, although defect detection module 152 and defect classification module 154 are shown as two separate components, those skilled in the art understand that a single module may be utilized for both the detection and classification tasks described herein.

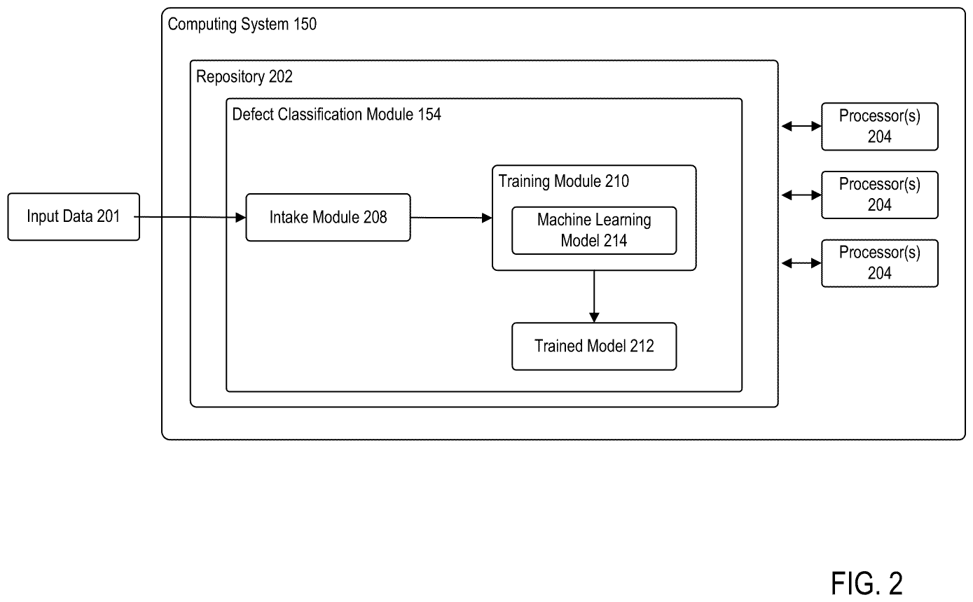

FIG. 2 is a block diagram of computing system 150, according to example embodiments. As shown, computing system 150 may include a repository 202 and one or more computer processors 204.

Repository 202 may be representative of any type of storage unit and/or device (e.g., a file system, database, collection of tables, or any other storage mechanism) for storing data. Further, repository 202 may include multiple different storage units and/or devices. The multiple different storage units and/or devices may or may not be of the same type or located at the same physical site. As shown, repository 202 includes at least defect classification module 154.

Defect classification module 154 may include intake module 208, training module 210, and trained model 212. Each of intake module 208 and training module 210 may be comprised of one or more software modules. The one or more software modules may be collections of code or instructions stored on a media (e.g., memory of computing system 150) that represent a series of machine instructions (e.g., program code) that implements one or more algorithmic steps. Such machine instructions may be the actual computer code the processor interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Intake module 208 may be configured to obtain or receive input data 201. Input data 201 may be include a plurality of image pairs. Each image pair may include a first image of an unetched specimen and a second image of the same specimen following an etch process. For example, as discussed above, certain defects can be detected on an unetched specimen but cannot be classified without destructive testing. To account for this, images of etched specimens were taken, and the defects identified in the images of the etched specimens were labeled. In some embodiments, for each image pair, intake module 208 may transfer defect labels from the unetched specimen to the etched specimen. For example, intake module 208 may include a script or automated process that identifies a first orientation of the specimen in the etched image, identifies a second orientation of the specimen in the unetched image, and may translate the labels from the etched image to the unetched image based on the corresponding first orientation and the second orientation. In some embodiments, intake module 208 may determine a first orientation of the etched image and a second orientation of the unetched image based on a marking on each of the etched image and the unetched image, respectively. In some embodiments, intake module 208 may determine a first orientation of the etched image and a second orientation of the unetched image using one or more computer vision techniques. For example, based on a layout of the defects detected in the etched image and the defects detected in the unetched image, intake module 208 may determine a mapping between the defects in the etched image to the defects in the unetched image.

In some embodiments, rather than intake module 208 mapping defects from the etched image of the specimen to the unetched image of the specimen, such process may be performed prior to input to intake module 208. For example, input data 201 may include a mapping of defect labels from the etched image to the corresponding unetched image.

Accordingly, intake module 208 may generate a training data set that includes a first set of unlabeled images of an unetched specimen and a second set of labeled images of an etched specimen. Such training data may assist training module 210 in training machine learning model 214 to not only detect but also classify defects on unetched specimens without destructive testing.

Training module 210 may be configured to train machine learning model 214 to classify defects on unetched specimens. For example, based on the training data set generated by intake module 208, training module 210 may train machine learning model 214 in a supervised manner, until machine learning model 214 is able to classify defects on unetched specimens with a threshold level of accuracy. For example, training and testing may be complete based on a generated confidence level of its prediction at an instant or over a specific time period. Such confidence levels, or thresholds, may provide a measure of statistical confidence in the prediction. In some embodiments, the confidence level may be expressed as a numerical probability of accuracy for the prediction. In some embodiments, the confidence level may be expressed as an interval or probability range.

Once trained, training module 210 may output a fully trained model 212.

In some embodiments, machine learning model 214 may be representative of a neural network, deep learning network, convolutional neural network, support vector machine, generative adversarial network, reinforcement learning model, regression-based model, transformer model, and the like. In some embodiments, machine learning model 214 may be representative of a statistical model.

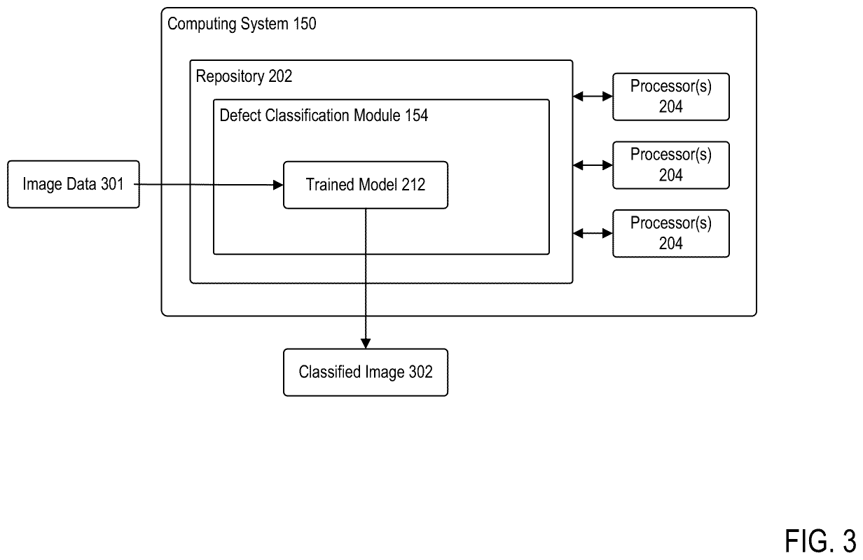

FIG. 3 is a block diagram illustrating computing system 150, according to example embodiments. As shown, after fully trained model 212 achieves a threshold level of confidence, it may be deployed to classify defects on unetched specimens.

Fully trained model 212 may receive, as an input, image data 301 captured by inspection system 102. In some embodiments, image data 301 may be representative of raw images generated by inspection system 102. In some embodiments, image data 301 may be representative of images following defect detection by defect detection module 152. For example, image data 301 may be representative of an image of an unetched specimen undergoing inspection, without bounding boxes around each detected defect.

Based on image data 301, fully trained model 212 may be able to classify each of the detected defects. For example, assume that fully trained model 212 includes at least two defects: a threading screw defect and a threading edge defect. Unlike conventional systems, fully trained model 212 is able to distinguish between the threading screw defect and the threading edge defect based on the training process. In this manner, fully trained model 212 is able to classify defects that it otherwise would not have been able to classify.

In some embodiments, as output, fully trained model 212 may generate classified image 302. Classified image 302 may be representative of an annotated image of the unetched specimen. For example, classified image 302 may include labels that indicate the type of each detected defect. In some embodiments, the labels may take the form of text-based labels. In some embodiments, the labels may take the form of color-coded bounding boxes.

In some embodiments, in addition to or in lieu of classified image 302, fully trained model 212 may generate a report that indicates a list of detected defects, their classifications, and associated coordinates on the specimen.

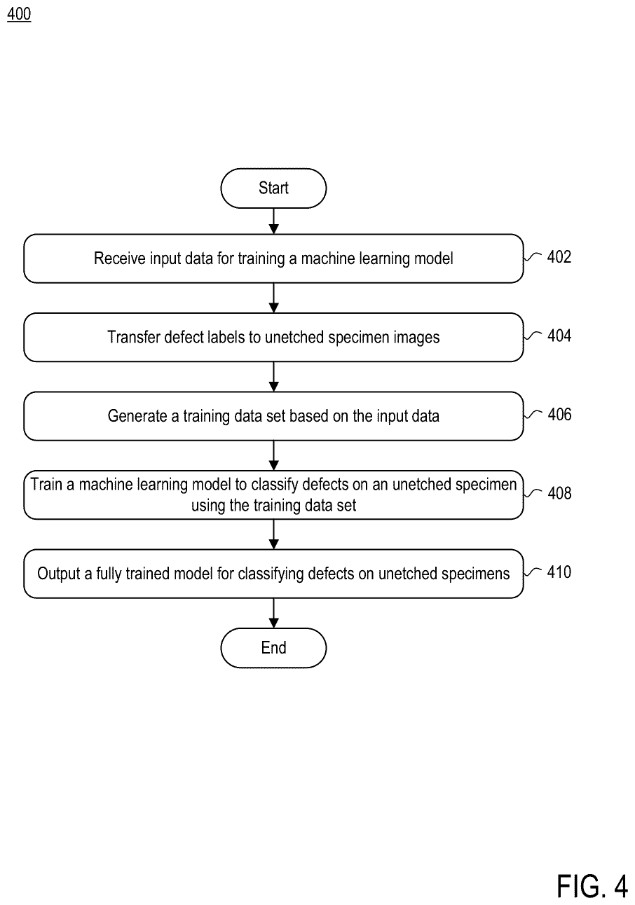

FIG. 4 is a flow diagram illustrating a method 400 of training a machine learning model to classify defects on unetched specimens, according to example embodiments. Method 400 may begin at step 402.

At step 402, computing system 150 may receive input data for training a machine learning model. In some embodiments, input data include a plurality of image pairs. In some embodiments, each image pair may include a first image of an unetched specimen and a second image of the same specimen following an etch process. In such embodiments, the second image of the same specimen following the etch process may include a label indicating the location of each defect and an associated classification of the defect. In some embodiments, each image pair may include a first image of an unetched specimen that does not include any defect classification labels and a second image of the unetched specimen that includes defect classification labels indicating the type of detected defect. In such embodiment, the labels from the etched image corresponding to the unetched specimen may be transferred to the unetched image.

In some embodiments, method 400 may include step 404. If, for example, the input data does not include labels on the etched specimens, then method 400 may include step 404. At step 404, for each image pair that includes an etched specimen and a corresponding unetched specimen, computing system 150 may transfer defect labels from the unetched specimen to the etched specimen. For example, intake module 208 may identify a first orientation of the specimen in the etched image, a second orientation of the specimen in the unetched image and may translate the labels from the etched image to the unetched image based on the corresponding first orientation and the second orientation.

In some embodiments, to transfer the labels from the etched image to the unetched image, computing system 150 may determine a first orientation of the etched image and a second orientation of the unetched image based on a marking on each of the etched image and the unetched image, respectively. In some embodiments, intake module 208 may determine a first orientation of the etched image and a second orientation of the unetched image using one or more computer vision techniques. For example, based on a layout of the defects detected in the etched image and the defects detected in the unetched image, intake module 208 may determine a mapping between the defects in the etched image to the defects in the unetched image.

At step 406, computing system 150 may generate a training data set based on the input data. In some embodiments, such as when the input data includes image pairs that include a labeled version of the unetched specimen image and an unlabeled portion of the unetched specimen image, the aggregation of the plurality of image pairs may act as the training data set. In some embodiments, such as when the input data includes image pairs that include an unetched specimen image and an etched specimen image, computing system 150 may generate a training data set that includes a labeled unetched specimen image, where the labels are transferred from a corresponding etched specimen image, and a corresponding unlabeled etched specimen image. Such process may be repeated for a plurality of actual or synthetic specimen images.

At step 408, computing system 150 may train a machine learning model 214 to classify defects on a specimen using the training data set. For example, training module 210 may train machine learning model 214 to classify defects on unetched specimens based on the training data set. In some embodiments, training module 210 may train machine learning model 214 in a supervised manner, until machine learning model 214 is able to classify defects on unetched specimens with a threshold level of accuracy. For example, training and testing may be complete based on a generated confidence level of its prediction at an instant or over a specific time period. Such confidence levels, or thresholds, may provide a measure of statistical confidence in the prediction. In some embodiments, the confidence level may be expressed as a numerical probability of accuracy for the prediction. In some embodiments, the confidence level may be expressed as an interval or probability range.

At step 410, computing system 150 may output a fully trained prediction model 212 based on the training. When deployed, fully trained prediction model 212 may be capable of classifying defects on a specimen, without requiring a destructive etch process.

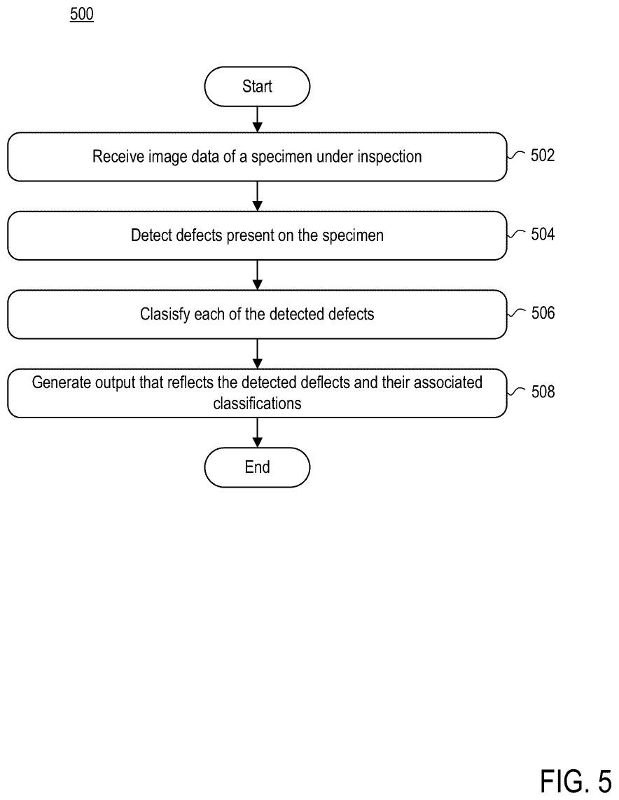

FIG. 5 is a flow diagram illustrating a method 500 for detecting defects on a specimen, according to some embodiments. Method 500 may begin at step 502.

At step 502, computing system 150 may receive image data of a specimen under inspection. In some embodiments, image data may be representative of raw images generated by inspection system 102.

At step 504, computing system 150 may detect defects that may be present on the specimen. In some embodiments, defect detection module 152 may detect defects on the specimen using one or more machine learning or computer vision techniques. In some embodiments, detecting defects may include defect detection module 152 placing bounding boxes around each of the detected defects.

At step 506, computing system 150 may classify each of the detected defects. For example, defect classification module 154 may analyze the image data to determine a classification of each defect. In some embodiments, determining a classification of each defect may include providing the image data, as input, to trained model 212.

At step 508, computing system 150 may generate an output that reflects the detected defects as well as their associated classifications. In some embodiments, as output, defect classification module 212 may generate a classified image. A classified image may be representative of an annotated image of the unetched specimen, with labels that indicate the type of each detected defect. In some embodiments, the labels may take the form of text-based labels. In some embodiments, the labels may take the form of color-coded bounding boxes.

In some embodiments, the output may include a report that indicates a list of detected defects, their classifications, and associated coordinates on the specimen.

### Micropit Defects

As previously described, micropits may occur on a surface of a specimen during fabrication. Because both micropits and other structures formed in or on the specimen reflect light during inspection, it is often difficult to determine whether an object or structure reflecting light is a micropit or a permissible object or structure.

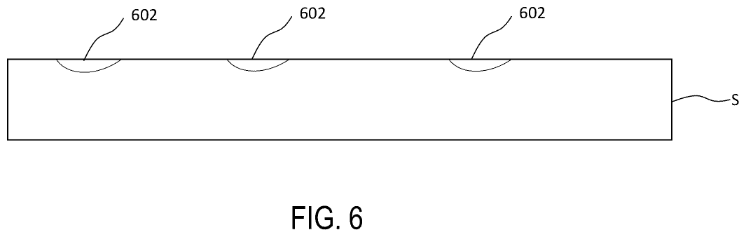

FIG. 6 illustrates a specimen S with micropits thereon, according to some embodiments. As shown, a micropit 602 may refer to a small, shallow opening or pit that is formed on the specimen S. In some embodiments, micropit 602 may be referred to as a pore. The size of a typical micropit 602 may be under 500 nm.

As described above, most optical systems, such as the inspection system 102, have a diffraction limit of 300 nm. Hence, micropits 602 are often not detected due their size (e.g., under 500 nm) and the diffraction limit (e.g., 300 nm). To account for this, conventional inspection systems previously relied on a laser illumination source to scatter illumination off micropits 602. However, micropits 602 are often washed out by the signal from the laser, thus resulting in the same issue of micropits 602 going undetected.

To account for this, one or more techniques disclosed herein utilize a darkfield imaging setting of inspection system 102 to capture images of specimens for analysis. By utilizing darkfield imaging instead of brightfield imaging, the unscattered beam is excluded from the imaging, thus resulting in the field around the specimen to be generally dark. Furthermore, because darkfield imaging utilizes oblique lighting, the darkfield illumination from inspection system 102 may illuminate the specimen at an angle. Such lighting will then bounce off the micropits, thus signaling the presence of a micropit at a location on the specimen that is reflecting the oblique lighting. In this manner, computing system 150 may be able to detect micropits using this technique, however classification remains a challenge with this method alone. Other artefacts such as particles and small bumps could produce a non-identical, but sufficiently similar visual signature that high-confidence classification is a challenge for human observers.

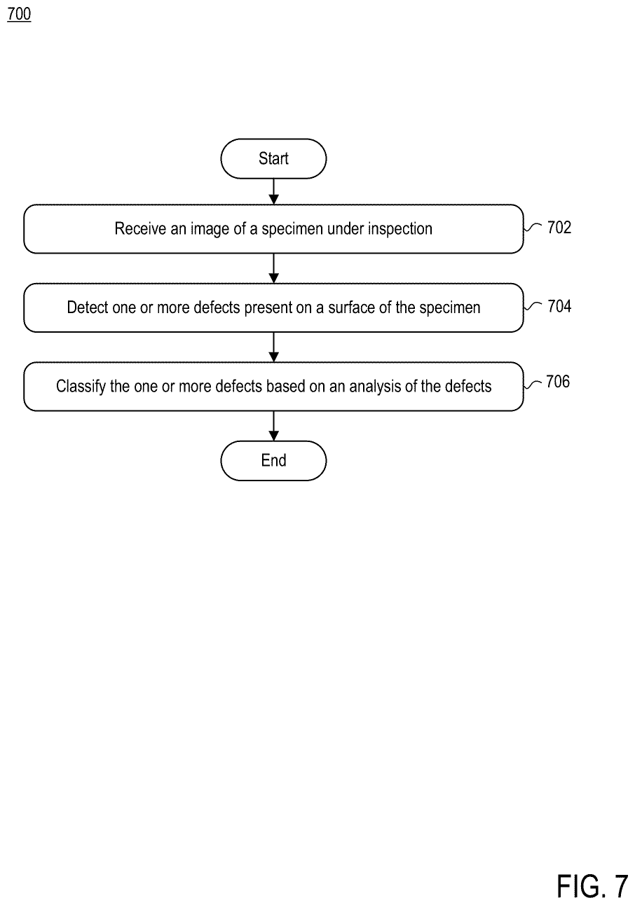

FIG. 7 is a flow diagram illustrating a method of inspecting a specimen for micropits, according to example embodiments. Method 700 may begin at step 702.

At step 702, computing system 150 may receive an image of a specimen under inspection. In some embodiments, the image of the specimen may be captured by inspection system 102. For example, inspection system 102 may illuminate the specimen using one or more light sources 104, 106. Inspection system 102 may utilize darkfield illumination to illuminate the specimen. For example, light sources 104, 106 may illuminate the specimen using oblique lighting. Imaging device 108 of inspection system 102 may capture the light reflecting off the specimen. Accordingly, the image received by computing system 150 may be generated using darkfield illumination.

At step 704, computing system 150 may detect one or more defects present on the surface of the specimen. For example, defect detection module 152 may analyze the image and identify any defects present therein. In some embodiments, defect detection module 152 may identify defects by identifying portions of the specimen that are reflecting light.

At step 706, computing system 150 may classify one or more defects present on the surface of the specimen. For example, given the nature of micropits, unlike other reflections, the reflection of light caused by a micropit may be substantially perpendicular to the surface of the specimen. Accordingly, defect classification module 154 may be trained to classify defects as being micropits based on the nature of the light reflected from the specimen.

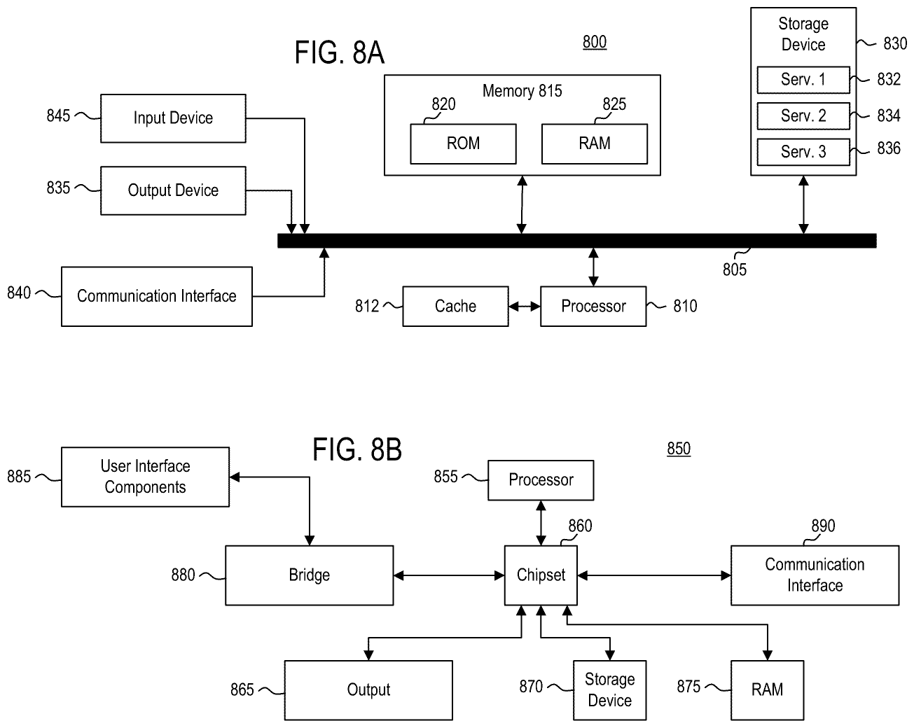

FIG. 8A illustrates a system bus architecture of computing system 800, according to example embodiments. System 800 may be representative of computing system 150 and/or controller 110. One or more components of system 800 may be in electrical communication with each other using a bus 805. System 800 may include a processing unit (CPU or processor) 810 and a system bus 805 that couples various system components including the system memory 815, such as read only memory (ROM) 820 and random-access memory (RAM) 825, to processor 810.

System 800 may include a cache of high-speed memory connected directly with, in close proximity to, or integrated as part of processor 810. System 800 may copy data from memory 815 and/or storage device 830 to cache 812 for quick access by processor 810. In this way, cache 812 may provide a performance boost that avoids processor 810 delays while waiting for data. These and other modules may control or be configured to control processor 810 to perform various actions. Other system memory 815 may be available for use as well. Memory 815 may include multiple different types of memory with different performance characteristics. Processor 810 may include any general-purpose processor and a hardware module or software module, such as service 1 832, service 2 834, and service 3 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction with the computing system 800, an input device 845 may represent any number of input mechanisms, such as a microphone for speech, a touch-sensitive screen for gesture or graphical input, keyboard, mouse, motion input, speech and so forth. An output device 835 may also be one or more of a number of output mechanisms known to those of skill in the art. In some instances, multimodal systems may enable a user to provide multiple types of input to communicate with computing system 800. Communications interface 840 may generally govern and manage the user input and system output. There is no restriction on operating on any particular hardware arrangement and therefore the basic features here may easily be substituted for improved hardware or firmware arrangements as they are developed.

Storage device 830 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 825, read only memory (ROM) 820, and hybrids thereof.

Storage device 830 may include services 832, 834, and 836 for controlling the processor 810. Other hardware or software modules are contemplated. Storage device 830 may be connected to system bus 805. In one aspect, a hardware module that performs a particular function may include the software component stored in a computer-readable medium in connection with the necessary hardware components, such as processor 810, bus 805, output device 835 (e.g., display), and so forth, to carry out the function.

FIG. 8B illustrates a computer system 850 having a chipset architecture that may represent at least the inspection system 102 or computing system 150. Computer system 850 may be an example of computer hardware, software, and firmware that may be used to implement the disclosed technology. System 850 may include a processor 855, representative of any number of physically and/or logically distinct resources capable of executing software, firmware, and hardware configured to perform identified computations. Processor 855 may communicate with a chipset 860 that may control input to and output from processor 855.

In this example, chipset 860 outputs information to output 865, such as a display, and may read and write information to storage device 870, which may include magnetic media, and solid- state media, for example. Chipset 860 may also read data from and write data to storage device 875 (e.g., RAM). A bridge 880 for interfacing with a variety of user interface components 885 may be provided for interfacing with chipset 860. Such user interface components 885 may include a keyboard, a microphone, touch detection and processing circuitry, a pointing device, such as a mouse, and so on. In general, inputs to system 850 may come from any of a variety of sources, machine generated and/or human generated.

Chipset 860 may also interface with one or more communication interfaces 890 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 855 analyzing data stored in storage device 870 or storage device 875. Further, the machine may receive inputs from a user through user interface components 885 and execute appropriate functions, such as browsing functions by interpreting these inputs using processor 855.

It may be appreciated that example systems 800 and 850 may have more than one processor 810 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A computer-implemented method for detecting defects on specimens in an inspection system comprising:
receiving a first set of images of a plurality of specimens having defects formed thereon;
receiving a second set of images of the plurality of specimens, wherein the second set of images comprises the plurality of specimens after undergoing a destructive etch process and labels corresponding to each defect;
transferring labels from the second set of images to the first set of images;
training a machine learning model to classify defects on unetched specimens based on the first set of images and the labeled first set of images;
determining that the machine learning model has achieved a threshold of accuracy; and
based on the determining, deploying the machine learning model in the inspection system.

2. The computer-implemented method of claim 1, wherein the defects comprise threading screw defects or threading edge defects.

3. The computer-implemented method of claim 1, wherein transferring the labels from the second set of images to the first set of images comprises:
determining a first orientation for each specimen in the second set of images;
determining a second orientation for each specimen in the first set of images; and
transferring the labels from the second set of images to the first set of images based on the first orientation for each specimen in the second set of images and the second orientation for each specimen in the first set of images.

4. The computer-implemented method of claim 3, wherein the first orientation and the second orientation are determined using markings on the specimen.

5. The computer-implemented method of claim 1, further comprising:
receiving a target image of a target specimen, the target image comprising a plurality of defects formed thereon, wherein the target specimen is unetched; and
classifying, using the machine learning model, the plurality of defects on the target specimen based on the training.

6. The computer-implemented method of claim 5, further comprising:
prior to classifying the plurality of defects, detecting the plurality of defects on the target specimen.

7. The computer-implemented method of claim 6, wherein the machine learning model detects the plurality of defects on the target specimen.

8. A non-transitory computer readable medium comprising one or more sequences of instructions stored thereon, which, when executed by a processor, causes a computing system to perform operations comprising:
receiving a first set of images of a plurality of specimens having defects formed thereon;
receiving a second set of images of the plurality of specimens, wherein the second set of images comprises the plurality of specimens after undergoing a destructive etch process and labels corresponding to each defect;
transferring labels from the second set of images to the first set of images;
training a machine learning model to classify defects on unetched specimens based on the first set of images and the labeled first set of images;
determining that the machine learning model has achieved a threshold of accuracy; and
based on the determining, deploying the machine learning model in an inspection system.

9. The non-transitory computer readable medium of claim 8, wherein the defects comprise threading screw defects or threading edge defects.

10. The non-transitory computer readable medium of claim 8, wherein transferring the labels from the second set of images to the first set of images comprises:
determining a first orientation for each specimen in the second set of images;
determining a second orientation for each specimen in the first set of images; and
transferring the labels from the second set of images to the first set of images based on the first orientation for each specimen in the second set of images and the second orientation for each specimen in the first set of images.

11. The non-transitory computer readable medium of claim 10, wherein the first orientation and the second orientation are determined using markings on the specimen.

12. The non-transitory computer readable medium of claim 8, further comprising:
receiving a target image of a target specimen, the target image comprising a plurality of defects formed thereon, wherein the target specimen is unetched; and
classifying, using the machine learning model, the plurality of defects on the target specimen based on the training.

13. The non-transitory computer readable medium of claim 12, further comprising:
prior to classifying the plurality of defects, detecting the plurality of defects on the target specimen.

14. The non-transitory computer readable medium of claim 13, wherein the machine learning model detects the plurality of defects on the target specimen.

15. A system comprising:
a processor; and
a memory having programming instructions stored thereon, which, when executed by the processor, causes the system to perform operations comprising:
receiving a first set of images of a plurality of specimens having defects formed thereon;
receiving a second set of images of the plurality of specimens, wherein the second set of images comprises the plurality of specimens after undergoing a destructive etch process and labels corresponding to each defect;
transferring labels from the second set of images to the first set of images;
training a machine learning model to classify defects on unetched specimens based on the first set of images and the labeled first set of images;
determining that the machine learning model has achieved a threshold of accuracy; and
based on the determining, deploying the machine learning model in an inspection system.

16. The system of claim 15, wherein the defects comprise threading screw defects or threading edge defects.

17. The system of claim 15, wherein transferring the labels from the second set of images to the first set of images comprises:
determining a first orientation for each specimen in the second set of images;
determining a second orientation for each specimen in the first set of images; and
transferring the labels from the second set of images to the first set of images based on the first orientation for each specimen in the second set of images and the second orientation for each specimen in the first set of images.

18. The system of claim 17, wherein the first orientation and the second orientation are determined using markings on the specimen.

19. The system of claim 15, further comprising:
receiving a target image of a target specimen, the target image comprising a plurality of defects formed thereon, wherein the target specimen is unetched; and
classifying, using the machine learning model, the plurality of defects on the target specimen based on the training.

20. The system of claim 19, further comprising:
prior to classifying the plurality of defects, detecting the plurality of defects on the target specimen.
